(19) United States
(12) Patent Application Publication
(10) Pub. No.: US 2015/0317403 A1
(43) Pub. Date: Nov. 5, 2015

(54) SYSTEM AND METHOD FOR MANAGEMENT OF DATA BASED BOOKMARKS

(71) Applicant: Reduxio Systems LTD., Petach Tiqva (IL)

(72) Inventors: Erez VOITIZ, Karkur (IL); Robert HOFFNER, Ashdod (IL)

(73) Assignee: REDUXIO SYSTEMS LTD., Petach Tiqva (IL)

(21) Appl. No.: 14/703,193

(22) Filed: May 4, 2015

Related U.S. Application Data
(60) Provisional application No. 61/988,253, filed on May 4, 2014.

(51) Int. Cl. G06F 17/30

(52) U.S. Cl. CPC G06F 17/30884; G06F 17/30117

(57) ABSTRACT

A method and a data based bookmark management system for data based bookmark management in a storage unit are provided. The method includes performing an analysis of a plurality of bookmarks assigned in at least one logical unit number (LUN) of the storage unit to identify at least one bookmark having an expiration time that has been reached; deleting the identified at least one bookmark; determining that data referred by the deleted bookmark is not referred by at least another bookmark of the plurality of bookmarks having an expiration time that has not been reached; and removing from the storage unit the data respective of the deleted at least one bookmark, upon determination that the data is not referred to by the at least another bookmark.

### CROSS-REFERENCE TO RELATED APPLICATIONS

This application claims the benefit of U.S. Provisional Application No. 61/988,253 filed on May 4, 2014, the contents of which are hereby incorporated by reference.

### TECHNICAL FIELD

The disclosure generally relates to managing a data storage system, and more particularly to erasure of the maintenance of data in such a storage system.

### BACKGROUND

In the computer industry, storage technology has evolved rapidly over the past number of years. There is a constant demand to provide storage systems with higher capacity and with data compacting capabilities, along with the need for managing, storing, and accessing the data in such storage systems.

Traditionally, the reduction of data has been managed, for example, by source coding or bit-rate reduction. Such techniques typically include encoding the data using fewer bits. Another common way to reduce the volume of the data is to perform compression using lossless compression techniques. This has become an even more demanding task as systems that allow retrieval of data from a location at its past values enable return in time of the data set to particular points in time. The result is additional data being stored to allow for such past retrieval to be possible.

Insofar as advanced storage technologies are developing, it becomes necessary to provide new technologies to reduce and/or delete irrelevant data, or alternatively to optimize the existing techniques. This is because the existing technologies are still deficient. As an example, management systems configured to perform compression of the data do not consistently satisfy the demands for a reduced size of data. This may be due to, for example, that such management systems typically do not allow for continued management of outdated data that can be removed. In some cases management is performed with limited scope and capabilities, requiring manual intervention, and is error prone, which may result in data inconsistency.

It would therefore be advantageous to provide a technical solution for reducing data in storage that overcomes the deficiencies of the prior art.

### BRIEF DESCRIPTION OF THE DRAWINGS

The subject matter that is disclosed herein is particularly pointed out and distinctly claimed in the claims at the conclusion of the specification. The foregoing and other objects, features, and advantages will be apparent from the following detailed description taken in conjunction with the accompanying drawings.

FIG. 1 is a schematic block diagram of a data management system utilized to describe various disclosed embodiments.

FIG. 2 is a schematic block diagram of bookmarks and blocks of a logical unit number (LUN) change with respect of time according to an embodiment; and,

FIG. 3 is a flowchart describing an operation for removing outdated data respective of a LUN of a storage unit according to an embodiment.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for data based bookmark management in a storage unit. The method comprises performing an analysis of a plurality of bookmarks assigned in at least one logical unit number (LUN) of the storage unit to identify at least one bookmark having an expiration time that has been reached; deleting the identified at least one bookmark; determining that data referred by the deleted bookmark is not referred by at least another bookmark of the plurality of bookmarks having an expiration time that has not been reached; and removing from the storage unit the data respective of the deleted at least one bookmark, upon determination that the data is not referred to by the at least another bookmark.

Certain embodiments disclosed herein include a data based bookmark management system. The system comprises a processing unit; at least one storage unit including at least one logical unit number (LUN); a memory communicatively connected to the processing unit, the memory maintains instructions that when executed configures the system to: perform an analysis of a plurality of bookmarks assigned in the at least one logical unit number (LUN) of the at least one storage unit to identify at least one bookmark having an expiration time that has been reached; delete the identified at least one bookmark; determine that data referred by the deleted bookmark is not referred by at least another bookmark of the plurality of bookmarks having an expiration time that has not been reached; and remove from the at least one storage unit the data respective of the deleted at least one bookmark, upon determination that the data is not referred to by the at least another bookmark.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Some exemplary and non-limiting embodiments disclosed herein include a data management system, and method thereof, configured to periodically handle cleaning of a continuous storage space of a storage unit, while ensuring data consistency. To this end, bookmarks are generated in a particular data space at different points in time. Each bookmark represents the point in time in which it was generated. Each bookmark is further accompanied with an expiration time. A retrieval of data at different points in time is enabled respective of the generation of a multiple bookmarks. In an exemplary embodiment, the method includes deletion of bookmarks respective of the expiration time that was set for each bookmark at inception, or updated thereafter. It should be understood that the multiple bookmarks may be used with different expiration times, as well as some of the bookmarks being periodic by nature while others having a one-time setting nature. Outdated data is removed from the storage unit respective of each bookmark determined to have expired.

FIG. 1 is an exemplary and non-limiting block diagram of a data management system 100 (referred hereinafter also a system 100) utilized to describe a periodic deletion of data that has expired while ensuring no loss of non-expired data according to one embodiment. A system 100 typically includes a processing unit 120. In an embodiment the processing unit 120 is configured to perform general control and computational functions. The system 100 also includes a memory unit 130 containing therein instruction 140 executable by the processing unit 120.

In an embodiment, the processing unit 120 may comprise, or be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing unit 120 and/or the memory unit 130 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The system 100 may be, but is not limited to, a dedicated stand-alone computer system, a server, a tablet computer, a laptop computer, and the like, however, its use is also envisioned in the likes of a smartphone, a cellular phone, a notebook computer, an intra-vehicle infotainment system (IVI), a personal computer (PC), and a wearable computing device.

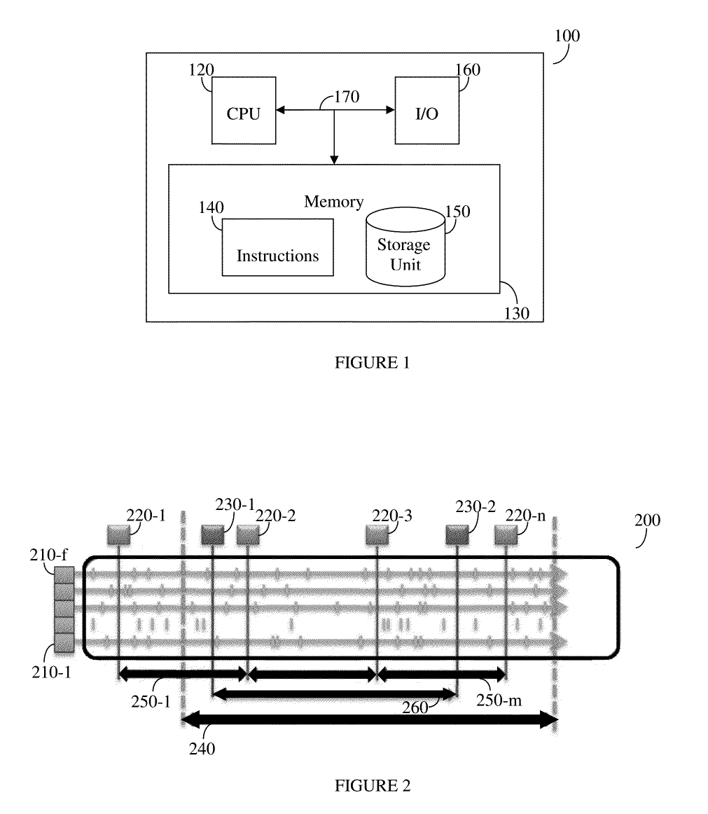

A storage unit 150, may be a part of the memory unit 130, or connected thereto as an external component. Such a connection may be a local bus, for example, bus 170, but, without limitation, a data communication network of any sort and combination. In one embodiment, the storage unit 150 includes at least one logical unit number (LUN) as further described herein below with respect of FIG. 2.

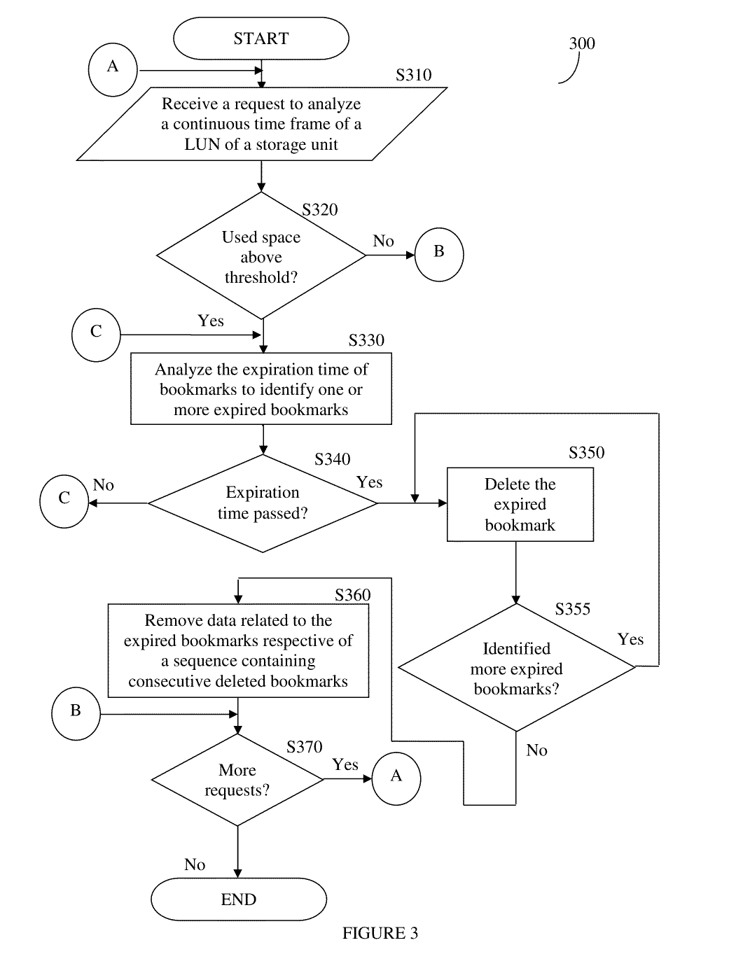

In one embodiment, the system 100 also includes an interface 160 that is communicatively connected to the processing unit 120 and the memory unit 130, for example, via the bus 170. The interface 160 is configured to receive inputs and provide display information from and to a user operating the system 100. In one exemplary and non-limiting embodiment, one or more requests are received through the interface 160 to remove outdated data from the storage unit 150. Such operation is described in more detail herein below with reference to FIG. 3.

FIG. 2 shows an exemplary and non-limiting schematic illustration of bookmarks and blocks of a LUN 200 of a storage unit, such as storage unit 150, according to an embodiment. FIG. 2 shows the changes performed to the blocks of the LUN 200 respective of time. One LUN 200 is described herein, merely for the sake of simplicity of the description. However, in other embodiments there may be a plurality of LUNs associated with the storage unit 150.

The LUN 200 includes one or more blocks 210-1 through 210-f. Each block 210 is configured to store at least a copy of data from another block. Such copied data is stored respective of one or more bookmarks, e.g., 220-1 through 220-n, 230-1 through 230-2, and so on. Each bookmark 220 and/or 230 represents a point in time in which the bookmark was generated. A retrieval of data in different points in time is enabled respective of the generation of a multiple bookmarks 220 and/or 230. Each bookmark 220 and/or 230 may be set manually by a user operating a computing device, such as a system 100.

In another embodiment, each bookmark 220 and/or 230 may be set automatically according to user defined rules, which in an embodiment, are received through the interface 160 of the system 100. In some embodiments, a system, such as system 100, may generate rules for generating bookmarks. Generation of bookmarks may be performed by monitoring user interaction of the system, determining usage patterns, and generating rules correlating with the usage patterns. For example, the system 100 is configured to determine that a user has set a bookmark every other day for the past 10 days, between 8 am and 10 am, by monitoring the user interaction with the system 100. The system 100 is further configured to determine a usage pattern of a recurring cycle, and generates a rule of setting a bookmark every other day at 9 am. The generated rule may be activated automatically, or may be displayed for a user to confirm activation.

Each bookmark, for example, the bookmark 220, is further accompanied with an expiration time 240. The expiration time 240 represents a point in time that, when reached, data related to the bookmark 220 is no longer relevant. The no longer relevant data may be removed. It should be understood that each bookmark 220 and/or 230 may be used with different expiration times, as well as some of the bookmarks, for example bookmarks 220, are periodic by nature while others have a one-time setting nature, for example, bookmarks 230.

As a non-limiting example, bookmarks 220-1 through 220-n correspond to cycle times 250-1 through 250-m, such that a bookmark 220 is created for every cycle time 250. As another non-limiting example, bookmarks 230-1 through 230-2 are set for one cycle 260 that include an automatic expiration time (not shown). It should be noted that the examples provided for bookmarks should not be construed as set with relatively short cycle times, and one or more bookmarks (not shown) may be set with a very long cycle time and/or with a very long expiration time, relative to what FIG. 2 may indicate. With respect to FIG. 2, ‘f’, ‘n’ and ‘m’ represent integer numbers having a value of ‘1’ or greater.

FIG. 3 shows an exemplary and non-limiting flowchart 300 describing the operation for managing data based on bookmarks analysis according to an embodiment. In S310, a request is received through an interface, for example, the interface 160 of the system 100, to analyze at least one LUN of the storage unit 150, for example, LUN 200. Such a request may be initiated by a user or automatically by the system 100 at predefined times (e.g., every day at midnight) or when the used space reaches a certain threshold (e.g., 80% of the allowed quota).

In S320, it is checked whether the utilized storage space associated with the LUN 200 is above a predetermined threshold, and if so, execution continues with S330; otherwise, execution continues with S380. In exemplary embodiment, the threshold may be a predetermined value set based on a storage quota allocated or guaranteed to a user of the system 100.

In S330, bookmarks in a continuous time frame in the LUN 200 are analyzed to identify their expiration time. At any given time, the time frame includes a past time, defining its beginning and the current time, defining its end. The time frame may be static, dynamic, or adaptive. Static time frames are predetermined time frames that remain constant (e.g. one hour). Dynamic time frames are forcefully changed, for example, at a certain time of day, or on a certain day. Adaptive time frames are changed in response to changes in characteristics of the LUN and may vary depending on a variety of parameters.

In S340, it is checked whether the expiration time of at least one bookmark has passed, and if so, execution continues with S350; otherwise, execution returns to S330. In S350, the expired bookmark is deleted and execution continues with S355.

In S355, a check is performed to determine if the expiration time of another bookmark has passed. If yes, execution returns to S350, otherwise execution continues at S360.

In S360, data related to the expired bookmarks is removed respective of a sequence containing consecutive deleted bookmarks. According to an embodiment, the data is removed between at least one unexpired bookmark and an expired bookmark, while ensuring data consistency. Data may be referenced by a plurality of bookmarks, a portion of which have expired and a portion which have not expired. Ensuring data consistency includes at least performing a check to determine if the data related to the expired bookmark is not referenced by a bookmark which has not yet expired. If the data is referenced by another bookmark which is not expired, the data is not removed.

In an exemplary and non-limiting embodiments, data between a predetermine number of bookmarks is removed after the sequence containing consecutive deleted bookmarks. Such data is removed without deleting their bookmarks. In S370, it is checked whether additional requests are received, and if so, execution returns to S310; otherwise, execution terminates.

It should be noted that when a bookmark is deleted with respect to a continuous time frame of the LUN 200, a new bookmark cannot be set there.

The various embodiments disclosed herein can be implemented in hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for pedagogical purposes to aid the reader in understanding the principles disclosed and the concepts contributed by the inventor to furthering the art, and are to be construed as being without limitation to such specifically recited examples and conditions. Moreover, all statements herein reciting principles, aspects, and embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

A person skilled-in-the-art will readily note that other embodiments may be achieved without departing from the scope of the disclosure. All such embodiments are included herein. The scope of the disclosure should be limited solely by the claims thereto.

What is claimed is:

1. A method for data based bookmark management in a storage unit, comprising:
performing an analysis of a plurality of bookmarks assigned in at least one logical unit number (LUN) of the storage unit to identify at least one bookmark having an expiration time that has been reached;
deleting the identified at least one bookmark;
determining that data referred by the deleted bookmark is not referred by at least another bookmark of the plurality of bookmarks having an expiration time that has not been reached;
removing from the storage unit the data respective of the deleted at least one bookmark, upon determination that the data is not referred to by the at least another bookmark.

2. The method in claim 1, wherein the analysis is performed respective of any one of: a request received through an interface to remove outdated data and a volume of data of the at least one LUN exceeded a predefined threshold.

3. The method of claim 1, wherein each bookmark of the plurality of bookmarks includes a creation time and expiration time.

4. The method of claim 1, wherein the analysis of the plurality of bookmarks is performed over bookmarks in a continuous time frame.

5. The method of claim 1, further comprising:
generating a new bookmark of the plurality of bookmarks; and
retrieving data respective of at least one point in time associated with the generation of at least one bookmark.

6. The method of claim 5, wherein generating the new bookmark further comprises:
generating the new bookmark respective of at least one of: user interaction with the stored data, usage patterns of the stored data, and a user defined rule.

7. The method of claim 1, wherein removing the data from the storage unit further comprises:
determining that an amount of free space of the at least one LUN is below a predetermined threshold; and
removing the data of from the storage unit, upon determination that an amount of free space of the at least one LUN is below a predetermined threshold.

8. A computer software product containing instructions embodied in a tangible memory that when executed on a computing device performs the method of claim 1.

9. A data based bookmark management system, the system comprises:
at least one storage unit communicatively connected to a processing unit, wherein the at least one storage unit including at least one logical unit number (LUN);
a memory communicatively connected to the processing unit, the memory maintains instructions that when executed configures the system to:
perform an analysis of a plurality of bookmarks assigned in the at least one logical unit number (LUN) of the at least one storage unit to identify at least one bookmark having an expiration time that has been reached;
delete the identified at least one bookmark;
determine that data referred by the deleted bookmark is not referred by at least another bookmark of the plurality of bookmarks having an expiration time that has not been reached; and
remove from the at least one storage unit the data respective of the deleted at least one bookmark, upon determination that the data is not referred to by the at least another bookmark.

10. The system of claim 9, wherein the system is further configured to analyze the plurality of bookmarks respective of any one of: a request received through an interface to remove outdated data, and volume of data of the at least one LUN reached above a predefined threshold.

11. The system of claim 9, wherein each bookmark of the plurality of bookmarks includes a creation time and the expiration time.

12. The system of claim 9, wherein the analysis of the plurality of bookmarks is performed over bookmarks in a continuous time frame.

13. The system of claim 9, wherein the system is further configured to:
generate a new bookmark of the plurality of bookmarks; and
retrieve data respective of at least one point in time associated with the generation of at least one bookmark.

14. The system of claim 13, wherein the system is further configured to:
generate the new bookmark respective of at least one of: user interaction with the stored data, usage patterns of the stored data, and a user defined rule.

15. The system of claim 9, wherein the system is further configured to:
determine when an amount of free space of the at least one LUN is below a predetermined threshold; and
remove the data from the storage unit, upon determination that an amount of free space of the at least one LUN is below a predetermined threshold.
